(19) United States
(12) Patent Application Publication
(10) Pub. No.: US 2021/0303119 A1
(43) Pub. Date: Sep. 30, 2021

(54) MOBILE MESSAGING SYSTEM WITH INTERACTIVE ANIMATED ICONS AND SOUNDS AND METHOD FOR USE

(71) Applicant: Daniel Evan Notice, Parkland, FL (US)

(72) Inventor: Daniel Evan Notice, Parkland, FL (US)

(21) Appl. No.: 17/301,266

(22) Filed: Mar. 30, 2021

Related U.S. Application Data
(60) Provisional application No. 63/001,807, filed on Mar. 30, 2020.

(51) Int. Cl. G06F 3/0484; H04L 12/58; H04M 1/72436; H04M 1/72439; G06F 3/0481

(52) U.S. Cl. CPC G06F 3/0484; H04L 51/10; H04M 2201/42; H04M 1/72439; G06F 3/04817; H04M 1/72436

(57) ABSTRACT

The present invention provides a mobile messaging system comprising interactive animated icons and sounds, and method for use. The system comprises a computer having a user interface; and a downloadable app with a built-in database of sounds. The user method steps include downloading the app, signing up and setting a plurality of settings, incorporating a set of user contacts, accessing the built-in database of sounds; and messaging a contact from the set of contacts of the user. The messaging step further comprises incorporating a sound from the built-in database of sounds; creating at least one brief custom sound; and accessing a plurality of animated interactive bubbles. Settings may include wallpaper and bubble color. The user may sign up by a personal identifier selected from a phone number, an email address, a third party affiliate, or combinations thereof. The third party affiliate may be selected from Facebook, Twitter and Google.

### CROSS-REFERENCE TO RELATED APPLICATION

This application claims the benefit of priority of U.S. Provisional Application No. 63/001,807 filed Mar. 30, 2020, the contents of which are herein incorporated by reference.

### BACKGROUND OF THE INVENTION

The present invention relates to mobile computer communication applications, and more particularly, to a mobile messaging system comprising interactive animated icons and sounds, and method for use.

Communication in an ever-changing technological driven society has been dominated by icon expressions with the use of emojis, gifs, or the like, through text messaging. These communication systems lack other forms of alternative expressive communication.

Existing messaging apps in the field continue to conform to their peers and social norms by adding new emojis or stickers, as well as saturating their products and services with advertisements.

Existing messaging apps fail to offer a simpler and safer way to conduct text communication.

Existing apps may provide the ability for a user to copy and paste sound files to send through messages after the addition of a specific keyboard in the user settings. Such sound files come in large blocks with long durations, provide no specifications or categories on what the sound is when selecting it, provide poor sound quality and lack diversity of sounds.

Existing apps offer repetitive methods which work only for a short period of time when going through a “fad” phase. Unless something unique is introduced to the product line that does not cause frustration or boredom for the users, then most of these systems tend stagnate quickly.

A need exists for a mobile computer communication application which provides new and alternative mobile computer communication applications. Further a need exists for an animated, interactive icon communications system featuring sounds. Further a need exists for a broader selection of sounds, a simpler way to provide and share sounds. In addition, a need exists for a new unique form of communication through texting, which offers a simpler, safer way to text between friends and family.

### SUMMARY OF THE INVENTION

Advantageously, in one aspect, the present invention provides a mobile messaging system and method comprising an animated, interactive icon communications system featuring sounds.

In a further aspect the present invention provides new and alternative mobile computer communication applications with an animated, interactive icon communications system featuring sounds. The present invention provides a broader selection of sounds and a simpler way to provide and share sounds.

In one aspect the present invention provides an unprecedented alternative communication system featuring the use of selective sounds with interaction through animated objects.

In a further aspect, the present invention provides a new, unique form of communication through texting, which offers a simpler, safer way to text between friends and family.

In a still further aspect, the present invention provides an unprecedented communication system which differs from anything else in the field because it enhances how people communicate with each other in a more mysterious and interactive way. The present invention provides a unique approach of sending categorized selected sounds through animated objects, can be a more vivid enthusiastic way to express oneself through texting that has not been previously available.

The present invention distinguishes over and differs from previously available repetitive systems and methods which work only for a short period of time when going through a “fad” phase. The present invention offers an alternative to existing systems which cause frustration and boredom for the users.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a screenshot of the application;

FIG. 2 is a screenshot of the application;

FIG. 3 is a screenshot of the application;

FIG. 4 is a screenshot of the application;

FIG. 5 is a screenshot of the application;

FIG. 6 is a screenshot of the application;

FIG. 7 is a screenshot of the application;

FIG. 8 is a screenshot of the application;

FIG. 9 is a screenshot of the application;

FIG. 10 is a screenshot of the application;

FIG. 11 is a schematic view of key frames of the popping animation;

and

FIG. 12 is a screenshot of the application as viewed in an app store.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

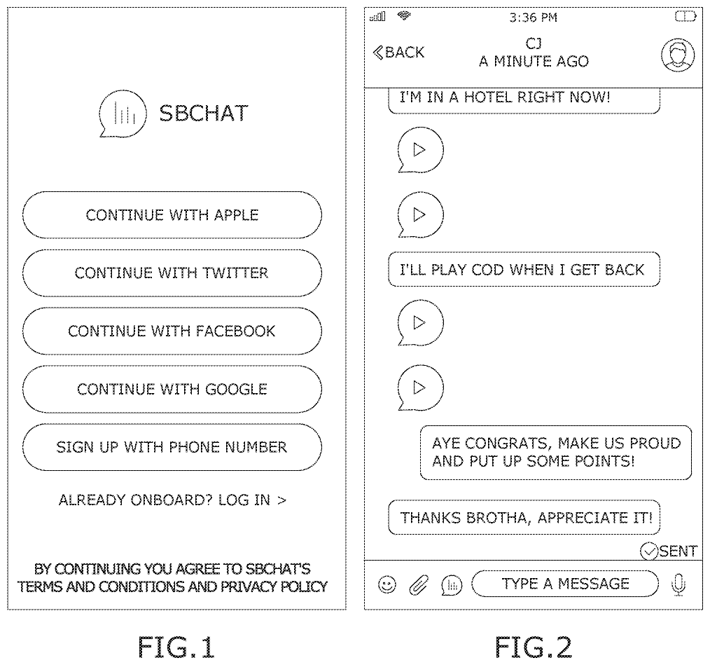

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention provides a mobile messaging system and method comprising an animated, interactive icon communications system featuring sounds. The animated, interactive icon communication system features the use of selective sounds with interaction through animated objects.

The system may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

a mobile messaging system and method comprising an animated, interactive icon communications system featuring sounds.

In an exemplary embodiment, the mobile messaging system of the present invention may comprise a mobile computing device, such as, for example without limitation, a mobile phone, a tablet, a notebook computer, or a desktop computer; and a downloadable mobile application installed on the mobile computing device. The system further comprises an animated interactive icon communications system featuring sounds. The present invention provides a mobile messaging system comprising interactive animated icons and sounds, and a method for use. The downloadable mobile application may further comprise a database of sounds.

In an exemplary embodiment the present invention provides a system for mobile communication, comprising a computer having a user interface; and a downloadable program product comprising a built-in database of sounds and a machine-readable program code for causing, when executed, the computer to perform a series of process steps. The process steps include downloading a mobile computer communication application; prompting a user to sign up and set a plurality of settings for the mobile computer communication system via the user interface; incorporating a set of contacts of the user; accessing the built-in database of sounds; and messaging a contact from the set of contacts of the user. The step of messaging further comprises incorporating a sound from the built-in database of sounds; creating at least one brief custom sound; and accessing a plurality of animated interactive bubbles. The plurality of settings may be selected from setting wallpaper and setting bubble color. The step of prompting the user to sign up and set settings for the mobile communication system may comprise the user signing up using a user personal identifier selected from a phone number, an email address, a third party affiliate, or combinations thereof. The third party affiliate may be selected from Facebook, Twitter, Instagram, Apple, Google or other affiliates.

In an exemplary embodiment the system may comprise a messaging application with interactive, animated icons and sounds. The system may include one or more of the following elements or components and combinations thereof.

downloadable mobile application software.

a module for registration or sign up of a user using a user phone number, a user email or a third-party affiliate account, such as for example without limitation, a social media account. The social media account may be selected from any social media platform, such as, for example without limitation, Apple, Facebook, Twitter, Google or the user's phone number. The module may then be used by a registered user for accessing the system.

a module for incorporating the user's phone contacts or email contacts.

a module for setting wallpaper, which may be in the system settings.

a module for setting bubble color, which may be in the system settings.

a built-in sound database, capable of being accessed by the user and by the system when the user is messaging.

a module for creating brief custom sounds, capable of being accessed by the user and by the system when the user is messaging.

a module for creating animated dynamic interactive bubbles, capable of being accessed by the user and by the system when the user is messaging.

The system incorporates and is capable of enabling a user to implement a method of using the system.

In an exemplary embodiment, the present invention may comprise a method or process including one or more of the following steps and combinations thereof.

The user downloads a mobile application in accordance with the present invention.

The user signs up or registers for the system using a phone number, an email address or a third-party affiliate account such as, for example without limitation, Apple, Facebook, Twitter, Google or the like.

The user permits the system to, and the system incorporates the user's phone contacts or email contacts.

The user accesses the system settings to set the system's wallpaper.

The user accesses the system settings to set the system's bubble color.

The user accesses a built-in system sound database when the user is messaging.

The user uses the system to create brief custom sounds when messaging.

The user uses the system to create animated dynamic interactive bubbles when messaging.

FIG. 1 is a screenshot of the application showing the user process of registration and accessing of the application.

FIG. 2 is a screenshot of the application showing the user process of communication using the system.

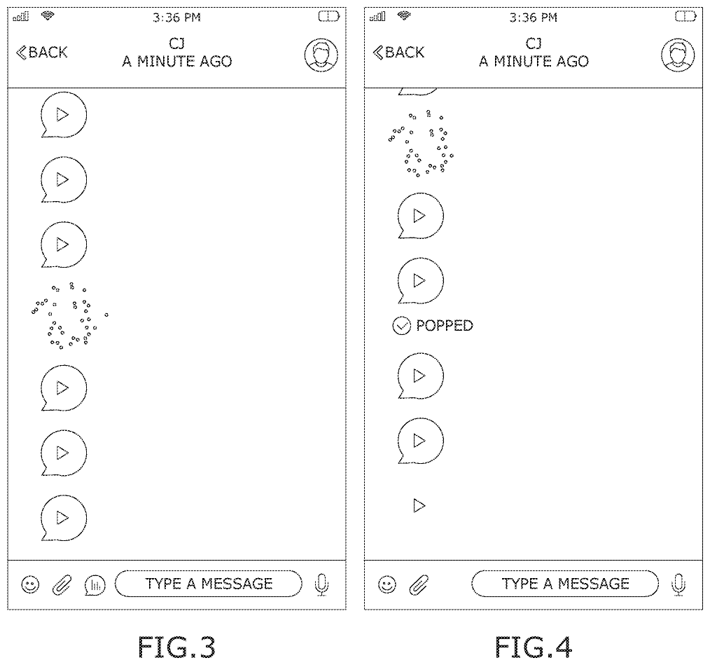

FIGS. 3 and 4 are screenshots of the application showing the user process of using the system to create brief custom sounds when messaging.

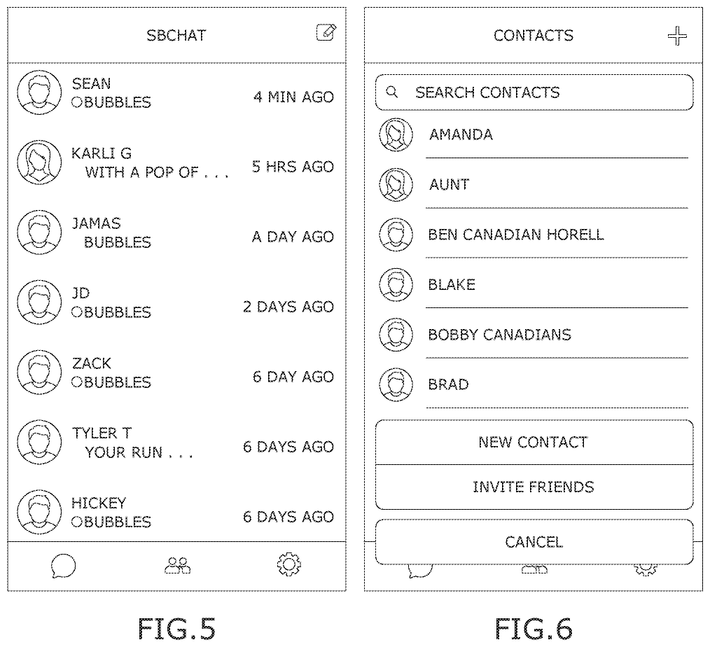

FIG. 5 is a screenshot of the application showing the user history of creating dynamic animated bubbles when messaging and creating brief custom sounds when messaging.

FIG. 6 is a screenshot of the application showing the user contacts and the system accessing the user contacts.

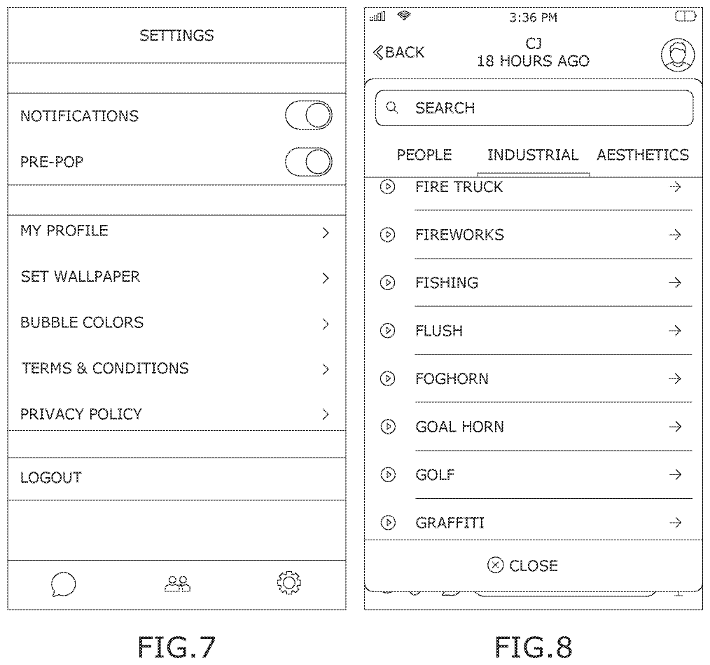

FIG. 7 is a screenshot of the application showing the application settings including settings for setting wallpaper, setting bubble color and selecting sounds.

FIG. 8 is a screenshot of the user accessible sound database.

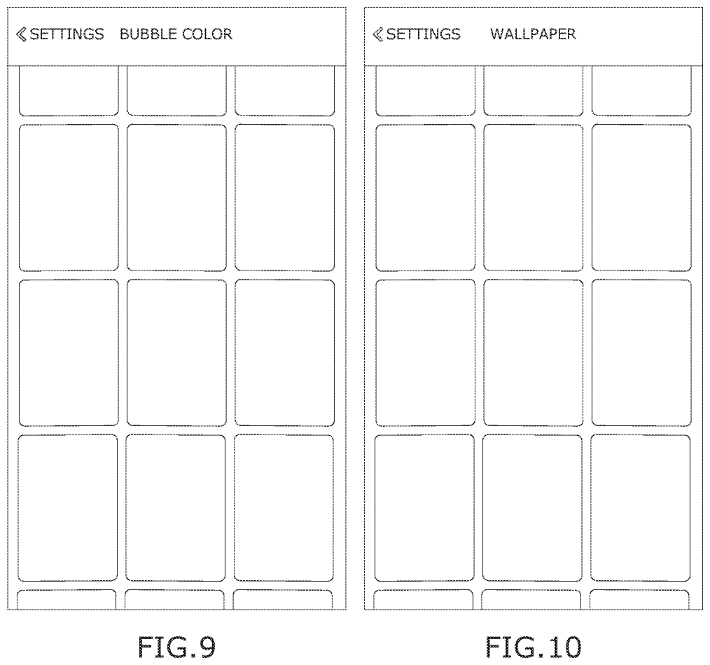

FIG. 9 is a screenshot of the application showing the bubble color settings, from which a user may select bubble color. The colors may be any color.

FIG. 10 is a screenshot of the application showing the wallpaper settings, from which the user may select wallpaper color or pattern. The colors may be any color, and the patterns may be any pattern.

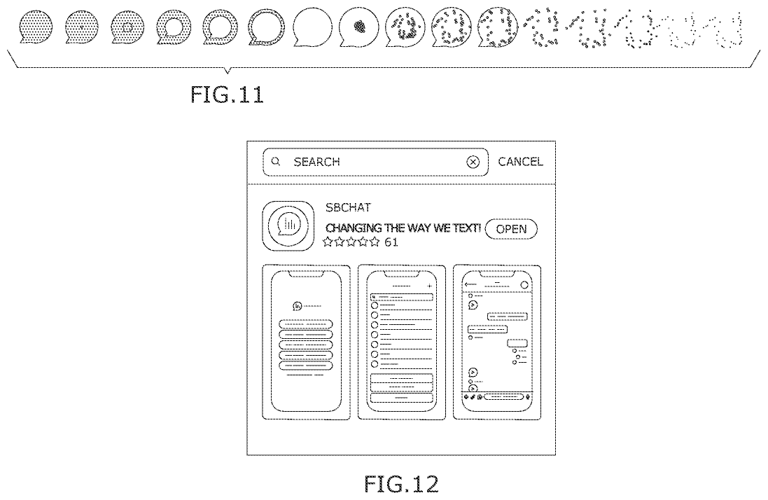

FIG. 11 shows a schematic view of key frames of the popping animation.

FIG. 12 is a screenshot of the mobile application as viewed in an app store from which the user may access and update the mobile application and application software on the user's mobile device.

In an exemplary embodiment the present invention may work or function in the following manner. All components within the mobile application amplify user experience and interaction. Users of the application may incorporate their phone contacts to begin messaging with friends and family. User then may change their wallpaper color, bubble colors and profile picture in the settings tab to enhance customization within conversations. When texting, users may not only be able access various categories of sounds within the sound database to send to recipients, but also be able to create their own unique up to 5 seconds of custom sounds to send. When receiving these sounds, the sounds are sent or conveyed through animated bubbles. The recipient would interact and “tap” to “pop” open the bubble, thus emitting the selected or brief custom made sound.

To create this invention, someone would need to know how to develop in multiple computer programming languages, know how to make creative animations, as well as create and organize hundreds of brief specific sound effect clips within a database.

All of the elements of the mobile application described herein are necessary to keep users engaged with sending sounds within conversations. Other elements that may be added may include group messaging, and sending gifs and videos. These optional additional elements may significantly enhance the user experience, making the functionality of the present invention far superior and simpler to use than other messaging applications with a broader audience of users.

In an exemplary embodiment, the messaging app of the present invention may be used by any users who wish to express and convey themselves in a more vocalized, animated way. Communicating with an alternative, interactive, animated icon with the use of sounds will enhance and personalize every user's conversation through texting.

The present invention provides a messaging app which introduces an unprecedented alternative, animated, interactive icon communications system featuring sounds. The present invention improves on these issues by introducing a new unique form of communication through texting, as well as offering a simpler, safer way to text between friends and family.

In summary, the present invention provides a mobile messaging system and method comprising an animated, interactive icon communications system featuring sounds. The animated, interactive icon communication system features the use of selective sounds with interaction through animated objects.

In an exemplary embodiment the present invention provides a system for mobile communication, comprising a computer having a user interface; and a downloadable program product comprising a built-in database of sounds and a machine-readable program code for causing, when executed, the computer to perform a series of process steps. The process steps include downloading a mobile computer communication application; prompting a user to sign up and set a plurality of settings for the mobile computer communication system via the user interface; incorporating a set of contacts of the user; accessing the built-in database of sounds; and messaging a contact from the set of contacts of the user. The step of messaging further comprises incorporating a sound from the built-in database of sounds; creating at least one brief custom sound; and accessing a plurality of animated interactive bubbles. The plurality of settings may be selected from setting wallpaper and setting bubble color. The step of prompting the user to sign up and set settings for the mobile communication system may comprise the user signing up using a user personal identifier selected from a phone number, an email address, a third party affiliate, or combinations thereof. The third party affiliate may be selected from Facebook, Twitter and Google.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications, variations and changes in detail may be made without departing from the spirit and scope of the invention as set forth in the following claims.

What is claimed is:

1. A system for mobile communication, comprising:
a computer having a user interface; and
a downloadable program product comprising a built-in database of sounds and a machine-readable program code for causing, when executed, the computer to perform the following process steps:
downloading a mobile computer communication application;
prompting a user to sign up and set a plurality of settings for the mobile computer communication system via the user interface;
incorporating a set of contacts of the user;
accessing the built-in database of sounds; and
messaging a contact from the set of contacts of the user, said messaging further comprising:
incorporating a sound from the built-in database of sounds;
creating at least one brief custom sound; and
accessing a plurality of animated interactive bubbles.

2. The system of claim 1 wherein the plurality of settings are selected from setting wallpaper, setting bubble color, and combinations thereof.

3. The system of claim 1 wherein prompting the user to sign up and set settings for the mobile communication system comprises the user signing up using a user personal identifier selected from a phone number, an email address, a third party affiliate, or combinations thereof.

4. The system of claim 3 wherein the third party affiliate is selected from Facebook, Twitter, Instagram, Apple and Google.

5. The system of claim 4 wherein the downloadable mobile application software further comprises:
a module for registration of the user, and use by the registered user for accessing the system;
a module for incorporating the user's phone contacts or email contacts;
a module for setting wallpaper;
a module for setting bubble color;
a module for creating brief custom sounds, capable of being accessed by the user and by the system when the user is messaging; and
a module for creating animated dynamic interactive bubbles, capable of being accessed by the user and by the system when the user is messaging.

6. A method for mobile communication by a user, the method comprising:
providing a system as in claim 5;
downloading the mobile application;
signing up to use the system by providing a phone number, an email address or a third-party affiliate account;
permitting the system to access and incorporate the set of contacts of the user;
setting the system's wallpaper;
setting the system's bubble color;
accessing the built-in system sound database while messaging;
using the system to create brief custom sounds when messaging; and
using the system to create animated dynamic interactive bubbles when messaging.
